(19) United States
(12) Patent Application Publication
(10) Pub. No.: US 2025/0108723 A1
(43) Pub. Date: Apr. 3, 2025

(54) ELECTRIC VEHICLE CHARGING STATION MANAGEMENT

(71) Applicant: LIIKENNEVIRTA OY / VIRTA LTD, Helsinki (FI)

(72) Inventor: Jussi AHTIKARI, Helsinki (FI)

(73) Assignee: LIIKENNEVIRTA OY / VIRTA LTD, Helsinki (FI)

(21) Appl. No.: 18/721,536

(22) PCT Filed: Dec. 13, 2022
(86) PCT No.: PCT/FI2022/050831

§ 371 Date: Jun. 18, 2024

(30) Foreign Application Priority Data
Dec. 21, 2021 (FI) 20216310

(51) Int. Cl. B60L 53/66; B60L 53/65; B60L 53/68

(52) U.S. Cl. CPC B60L 53/665; B60L 53/65; B60L 53/68; B60L 2250/20

(57) ABSTRACT

An arrangement for managing electric vehicle charging stations comprises an arrangement for receiving an encrypted identification code of a charging station from one of the two routes for receiving the identification code. The first route comprises using a generic reader software and a browser and the second route comprises using a specific application. Then the identification code and the selected route are used to route a workflow in order to start a charging session or other charging station workflow.

### DESCRIPTION OF BACKGROUND

The following disclosure relates to charging stations for electric vehicles. Particularly, the following disclosure relates to managing charging stations and initiating a charging session at a charging station.

Electric vehicle charging stations are used to charge electric cars and other electric vehicles. In the following disclosure, the expression ‘charging station’ is used for an arrangement comprising an appropriate socket for connecting a charging cable to a vehicle, typically a passenger car. Commonly a charging session begins after identifying the user and/or vehicle. The identification may be performed, for example, by using an identification tag or a mobile application.

When an electric vehicle arrives at a charging station a common difficulty is to understand who is operating the charging station. In some areas there are a plurality of charging operators that are having variable conditions for charging. The pricing may heavily depend on a possible membership of the charging operator. Charging operators may have different fee schedules for different memberships, and they may also allow charging by non-members, however, commonly at a higher price. Some charging stations are not public and cannot be used even if the customer is willing to pay the higher price.

A common problem of electric car drivers is that many of the charging stations do not have the needed information clearly and visible available. Thus, the driver might not know which is the correct mobile application or if it is possible or necessary to use a tag. The charging station might have additional information in form of a sticker or similar, however, the information might be out of date or otherwise incorrect.

The information mentioned in the above may be given in form of a text, barcode, QR code or similar. The QR code is commonly used as it is machine readable and has standardized modes that can be easily used in various applications, where the information needs to be read using a camera.

### SUMMARY

In the following disclosure an arrangement for managing electric vehicle charging stations comprises an arrangement for receiving an encrypted identification code of a charging station from one of the two routes for receiving the identification code is disclosed. The first route comprises using a generic reader software and a browser and the second route comprises using a specific application. Then the identification code and the selected route are used to route a workflow in order to start a charging session or other charging station workflow.

In an aspect an apparatus is disclosed. The apparatus comprises at least one processor configured to execute computer program code; at least one memory configured to store computer program code; and at least one network interface configured to communicate with external data communication devices. The apparatus is configured to receive an encrypted unique identification code of a charging station from a world wide web server or an application server, wherein the service server is configured to: determine the source of the received encrypted unique identification code of a charging station; decrypt the received encrypted unique identification code of a charging station; and launch a charging station workflow in accordance with the determined source and decrypted unique identification code of a charging station. A benefit of the aspect is to provide an arrangement, wherein a person at a charging station can start different charging station workflows using one single code or marking with different tools. The arrangement will identify the charging station and an access route. This provides a possibility to provide a simple and always similar way to start different types of workflows.

In an implementation the apparatus is further configured to determine if the charging station identified by the unique identification code is a public or limited access charging station. It is beneficial to start public and limited access workflows in a similar manner. The arrangement can identify the status without further instructions from the user.

In an implementation the apparatus is configured to route the launched charging station workflow to an identification site in case the source of the received encrypted unique identification code of a charging station is a world wide web server. It is beneficial to identify if the identification code was received from a world wide web server so that appropriate workflows with a world wide web user interface can be shown.

In an implementation the apparatus is configured to route the launched charging station workflow to the application control in case the source of the received encrypted unique identification code of a charging station is an application server. It is beneficial to identify if the identification code was received from an application server so that appropriate workflows with an application user interface can be shown.

In an implementation the apparatus is further configured to determine the charging station identified by the unique identification code is in limited use; and in response to the determined limited use the apparatus is further configured to route the charging station workflow to request a password. It is beneficial to use password check for limited use. It provides a convenient way of checking if the user is entitled to use the determined workflow.

In an implementation the apparatus is further configured to determine the charging station identified by the unique identification code is in service. It is beneficial to include information if the charging station is in service, deployment or in any other state that may prevent at least some users of accessing the charging station.

In an implementation the charging station workflow is one of the following: a charging process, charging station configuration, charging station installation or charging station analysis. It is beneficial to use the same process for initiating different workflows. It provides better user experience to ordinary charging customers, home charging station customers and maintenance and installation personnel.

In an aspect a system disclosed. The system comprises a service server, wherein the service server is an apparatus as described in the above, a world wide web server; and an application server. One of the world wide web server and the application server is configured to receive encrypted unique identification code of a charging station.

In an implementation the system further comprises a charging station associated with a unique identification code, wherein the unique identification code is provided in a form of a permanent code comprising a domain name part and an encrypted unique identification code. It is beneficial to use a permanent code. When the code is arranged to the charging station at factory or other manufacturing site it cannot be changed or it cannot get lost. Furthermore, when one instance is responsible for issuing unique identification codes it can be secured that the codes are unique and can be tied with additional information, for example charging station specification and initial parameters.

In an implementation the unique identification code is provided in a form of a QR code. It is beneficial to use QR code is commonly used and efficient code suitable for the purpose, wherein the unique identification code is scanned using a camera of a mobile phone or other mobile device.

In an implementation the system further comprises a mobile device, wherein the mobile device is used to read the unique identification code and to send the unique identification code to the service server via the world wide web server or the application server.

In an aspect a method for initiating a charging station workflow is disclosed. The method comprises: reading a unique identification code of a charging station using a mobile device; and transmitting the read unique identification code of a charging station to the apparatus or the service server as described in the above.

### BRIEF DESCRIPTION OF THE DRAWINGS

The accompanying drawings, which are included to provide a further understanding of the arrangement for electric vehicle charging station management and constitute a part of this specification, illustrate embodiments and together with the description help to explain the principles of the arrangement for electric vehicle charging station management. In the drawings:

FIG. 1 is an example block diagram of an electric vehicle charging arrangement,

FIG. 2 is an example block diagram of an electric vehicle charging arrangement,

FIG. 3 is an example of a method for a charging arrangement, and

FIG. 4 is an example of a routing workflow for an electric vehicle charging arrangement.

### DETAILED DESCRIPTION

Reference will now be made in detail to the embodiments, examples of which are illustrated in the accompanying drawings.

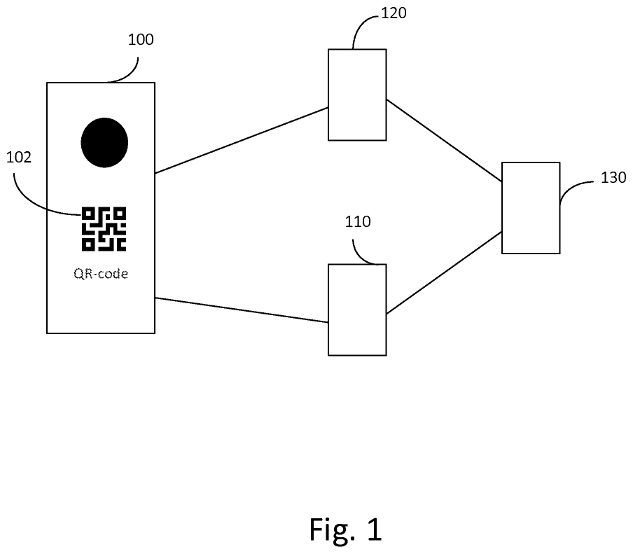

In FIG. 1, an example of a block diagram of an electric vehicle charging arrangement including a charging station comprising a readable code as explained in the following. In the following a method and an arrangement for managing a charging station and charging station workflows is discussed. In the following an example wherein the selected charging station workflow is a process for initiating a charging session is discussed. This example is chosen as it is the most typical case, however, additional example implementations that can benefit of similar identification will be explained in below.

In the example of FIG. 1 a charging station 100, mobile devices 110 and 120, and a backend system 130 are shown. The charging station 100 is an ordinary charging station that can be controlled conventionally using different means. In the following controlling using a mobile device 110 or 120 is explained. Mobile devices 110 and 120 are used as examples. Thus, there is no requirement of having two mobile devices but typically a person charging the vehicle has only one mobile device that is used for controlling charging sessions. In the example of FIG. 1 two mobile devices are shown because the arrangement comprises two methods for the required identification.

The charging station 100 comprises the ordinary charging functionality that is not shown in the figure. Thus, it is capable of charging an electric vehicle by providing electricity. Charging station is a physical object that needs to be connected to the electric grid and to vehicles that are charged. Furthermore, the charging station comprises a data communication connection and typically also one or more displays and control buttons. The charging station 100 further comprises an identification code, such as a QR code 102. The QR code 102, or optionally any other suitable code, is provided already when the charging station is manufactured. Thus, the code is a permanent marking. In order to be able to identify the charging station, it needs to be unique or form a part of a larger unique identification code. In the example of FIG. 1 the identification comprises a URL or any other suitable internet address. The URL comprises a domain name that is normally in human-readable form. In addition to the domain name the URL comprises a unique identification code identifying the charging station. The unique identification code may be implemented in many ways, for example, it may be a reference number of the charging station operator, reference number of the charging station manufacturer or similar. The unique identifying code of the charging station may be encrypted. Together the domain name and the unique identification code form a URL that is fully functional.

In the example of FIG. 1 mobile devices 110, 120 are used to scan the QR code 102 and act accordingly. The mobile device 110 uses a common QR code reader for scanning the QR code 102. The reader detects that the content of the QR code 102 is a URL. The URL determines a world wide web address. The QR code reader submits the content to a common browser application that directs to a web page, which is a charging station management site. As the URL comprises the unique identification code of the charging station, the management site is able to control the correct charging station. In the example of FIG. 1 the management software for charging stations is hosted at a server 130, which is also hosting the world wide web site for the service.

Mobile device 120 uses a particular charging station operator application for scanning the QR code. If the application is from the same operator or otherwise supports the charging station, the application may be used to initiate the charging. The application extracts the unique identification code from the URL and sends the unique identification code to the server 130. The application may provide additional information, such as account details or other payment information so that the charging can be started conveniently.

The server 130 may be a traditional server or a cloud service. The server 130 identifies from where the unique identification code was received. If it was received through a world wide web site a website will be shown to the user. The website may comprise a login screen with a possibility to charge as a guest without a valid registration if the owner of the charging station provides this possibility. When the server receives the unique identification code from the application the server 130 typically has all information needed for charging. Thus, it may show a confirmation button or similar control so that the charging can be started.

In the above an example wherein the common QR code reader submits the read URL to a browser maybe implemented so that instead of opening the URL in a browser the mobile device detects that the read URL should be opened with an associated application. In such case, even if the charging session is initiated as described with regard to mobile device 110, the process follows the example of mobile device 120. Thus, when the mobile device is configured appropriately the person initiating a charging session may use the common QR reader as a first step.

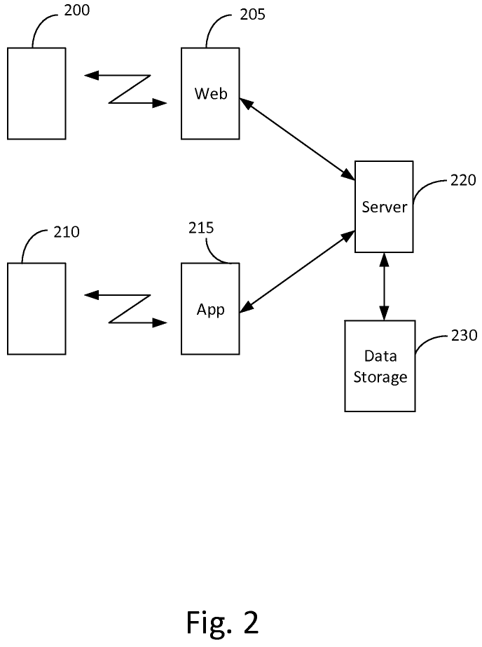

FIG. 2 discloses a second example of an arrangement for managing electric vehicle charging stations. In the example two ways of initiating a charging session are shown. In the figure a first mobile device 200 and a second mobile device 210 are shown. These mobile devices may be any network connected mobile devices, however, typically they are modern mobile phones that are capable of executing applications designed for mobile devices. In the figure two devices are shown in order to illustrate the two possible ways of using the arrangement. Thus, these two routes are optional to each other and a person initiating a charging session will use only one of the options at time.

The mobile device 200 comprises a browser for web-based content. Furthermore, the mobile device 200 comprises a scanner software for scanning or reading a QR code. The scanner software is typically configured so that when an URL is detected the scanner software transmits the URL to the browser. The browser opens the web page according to the URL.

When the mobile device 200 scans a QR code it will be translated into an URL, such as: “https://www.virtaglobal.com/qr/MVqJteBS7”. The URL is composed of a domain name part, which serves as an address for a www-server 205. The URL further comprises an identification code “MVqJteBS7”, which may be a unique identification code associated with the charging station, from where the QR code is scanned. In this case the identification code may be, for example, 100180, which is then encrypted using a private encryption key. Instead of a simple identification number a longer identification code may be used. Furthermore, the code may include additional data. The only requirement for the code is that is must be able to identify the charging station.

When the mobile device 200 accesses the website according to the QR code the web server 205 extracts the identification code from the URL and directs the user to a webpage. The webpage comprises controls for starting a charging session. The www server 205 is connected to a service server 220. In the example of FIG. 2 the service server 220 comprises functionality for controlling charging station and also information required for invoicing. The server may use additional data storage 230, for example, for storing temporary or permanent customer data.

When the mobile device 200 connects to the www server 205 the web page providing the controls for starting a charging session may have a login page for registered customers and/or a guest login allowing people to use the charging service without a need for registration. Furthermore, if the charging station is a private one the webpage can be configured to ask a private password to allow private charging sessions.

The mobile device 210 comprises a charging application. The charging application is connected to an application server 215. The application typically comprises the same functionality as described above for the web approach, however, it is possible to include more functionality. For example, there is no need for login as the application may be configured to do login. The same applies for private passwords as they can be stored. The application may extract the identification code of the charging station and send it in encrypted form the application server 215. The application server decrypts the identification code and instructs the service server 220 to initiate a charging session.

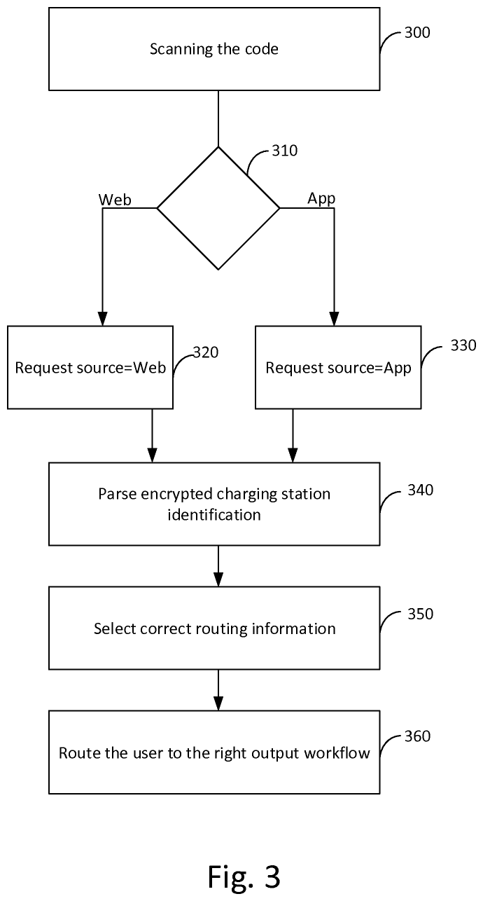

In FIG. 3 an example of a method for a charging arrangement is disclosed. In the example of FIG. 3 a user arrives at a charging station and initiates a charging session. The session is initiated by scanning a code provided at the charging station, step 300. Preferably the code is a permanent marking in the body of the charging station. Furthermore, preferably the code has been produced already at the manufacturing phase. Thus, the code does not change accidentally and is always at a desired location. The code is preferably provided in a form of a QR code that comprises a domain name portion and an identification code portion as explained in the above. A benefit of the permanent code is that it cannot be easily falsified. It is possible to have more than one copies of the identification code on the charging station so that the user may choose the most convenient one. Also other types of codes, permanent or temporary, may be used instead of a permanent QR code provided that they comprise the same information content.

When the user initiates a charging session the QR code or other suitable code is read using a mobile device, which is typically a mobile phone or other similar apparatus. The user of the mobile device may use a generic reader software or specific charging application reader, step 310. The generic reader software translates the read QR code into a web address, URL, which is then sent to a browser application, or to an application as explained in the above, which opens a web page at a web server, step 320, according to the domain name portion and the identification code portion. When the code is read, or at least processed, using a specific charging application, step 330, the application does not need the domain name portion and transmits only the identification code portion to the application server.

After receiving the identification code the code will be decrypted and parsed, step 340. The encryption arrangement may be implemented using public key cryptography such that the entity providing QR codes to charging station manufacturers has a secret key that is used to encrypt the charging station identification code. Then, when the identification code is decrypted a corresponding public key is used. This improves security as the secret key can be held in one place and is used only when issuing new identification codes that need to be encrypted.

Based on the decrypted and parsed charging station identification the routing information can be determined, step 350. This may be, for example, retrieved from a routing table using the decrypted and parsed charging station identification code. In addition to the information retrieved from the routing table additional information, such as the user identification and other user or charging station specific information maybe used. Finally, the user is routed to the correct workflow, step 360. The workflow may involve retrieving additional information, that may cause a change in the routing so that it will be changed from the original to an updated one. Examples of possible routing will be discussed in below.

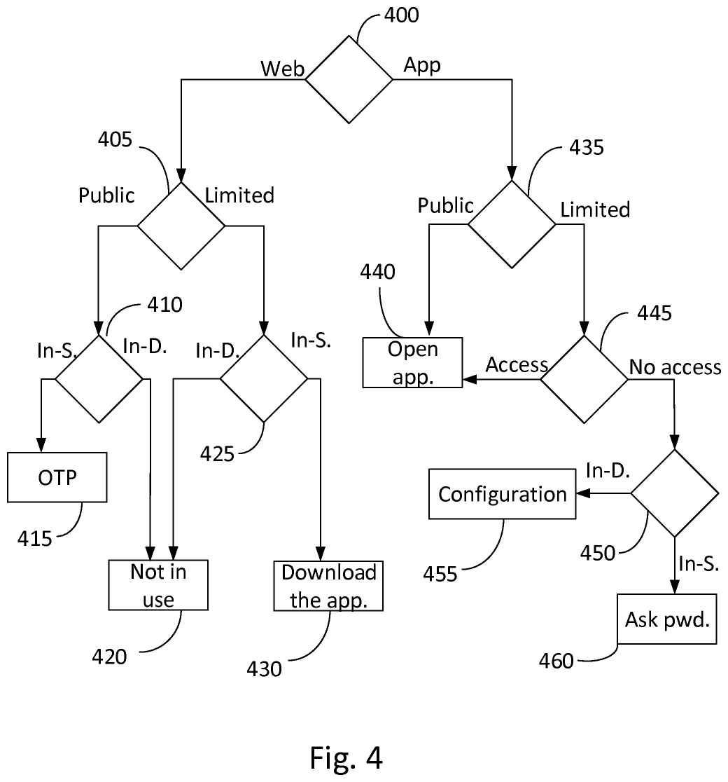

FIG. 4 discloses an example of a routing workflow in a form of a graph. As explained above, first it is determined if the request to start a charging session is initiated by an application or a browser, step 400. In the following—it is first assumed that the request is received from a browser. After determining the source the access setting of the charging station is checked, step 405. The access setting indicates if the charging station is in public or limited use. If the charging station is in public use, the routing proceeds to step 410, wherein it is determined if the charging station is in deployment or in service. If the charging station is in service a one-time payment web page is generated and shown to the customer, step 415. If the charging station is in deployment, the customer will see a web page indicating that the charging station is still in deployment and not in use, step 420. In case of limited access, the similar determination of being in use is done in step 425. Again, if the charging station is still in deployment, the routing proceeds to step 425. If the charging station is in limited access mode and in service, the customer is shown a web page asking to download, step 430, the application and register as the charging station is in limited access mode.

In the above public and limited access is used to indicate if a member of general public may access the charging station. However, it should be understood that using a public charging station commonly requires an identification of a person using the charging station and charging prices applied to the person may vary based on a subscription model. The limited access typically means that a person wishing to use the charging station needs to be a member in the group to whom the use of the charging station is allowed. The access may be verified using several means, for example, the account details in the application used for initiating a charging session or other charging station workflow. If the request for a charging session is received from the application the routing proceeds similarly first to check if the charging station is in public or limited use, step 435. If the charging station is in public use an application view with a possibility to start the charging session is shown to the customer 440. If the charging station is in limited use, the system is configured to check if this customer has access to it, step 445. If the customer has the access again a view with a possibility to start a charging session is shown to the customer, step 440. If the customer does not have the access the status of the charging station is checked, step 450. If the charging station is in deployment, the station configuration may be opened, step 455, if the user has an access to configure this particular station. The access to configure may be confirmed by password or similar. If the charging station is in service the application may ask a password for accessing the station, step 465. If the password is entered, the application may start charging or show the view for starting the charging. The password may be started for a later use. If the customer arrives later at the same charging station, and the password hasn't been changed, the charging session may start automatically.

In the above an example of a workflow routing is discussed. As mentioned above, the example is focusing on a charging session initiation merely because that is the most common use case. In the example of FIG. 4 also configuration of a charging station is shown as an example. Typically, this configuration, when used in accordance with the routing graph of FIG. 4, is performed on an existing charging station and may relate to changing the configuration or the initial configuration, which may be done in one or more occasions. Furthermore, the arrangement may be used to tasks similar to configuring, such as running analytics, testing of a charging station or other similar maintenance related tasks, wherein the person performing the maintenance work needs to identify the charging station before performing the task. In the above the disclosure focuses on a public multiple user charging stations, however, the similar approach may be used when installing a home charging station or other private charging station. In such case the home charging station comprises the identification code and when a person is installing the home charging station the process guides the workflow so that the person installing the home charging station is guided to the correct workflow and the installation process is smooth and easy.

The above-mentioned method may be implemented as computer software which is executed in a computing device able to communicate with a mobile device. When the software is executed in a computing device, it is configured to perform the above-described inventive method. The software is embodied on a computer readable medium so that it can be provided to the computing device, such as the service server 130 of FIG. 1.

As stated above, the components of the exemplary embodiments can include a computer readable medium or memories for holding instructions programmed according to the teachings of the present inventions and for holding data structures, tables, records, and/or other data described herein. A computer readable medium can include any suitable medium that participates in providing instructions to a processor for execution. Common forms of computer-readable media can include, for example, a floppy disk, a flexible disk, hard disk, magnetic tape, any other suitable magnetic medium, a CD-ROM, CD±R, CD±RW, DVD, DVD-RAM, DVD±RW, DVD±R, HD DVD, HD DVD-R, HD DVD-RW, HD DVD-RAM, Blu-ray Disc, any other suitable optical medium, a RAM, a PROM, an EPROM, a FLASH-EPROM, any other suitable memory chip or cartridge, a carrier wave or any other suitable medium from which a computer can read.

It is obvious to a person skilled in the art that with the advancement of technology, the basic idea of the arrangement for electric vehicle charging station management may be implemented in various ways. The arrangement for electric vehicle charging station management and its embodiments are thus not limited to the examples described above; instead they may vary within the scope of the claims.

1. An apparatus comprising:
at least one processor configured to execute computer program code;
at least one memory configured to store computer program code; and
at least one network interface configured to communicate with external data communication devices,
wherein the apparatus is configured to receive an encrypted unique identification code of a charging station from a world wide web server or an application server, wherein the apparatus is configured to:
determine the source of the received encrypted unique identification code of the charging station;
decrypt the received encrypted unique identification code of the charging station; and
launch a charging station workflow in accordance with the determined source and decrypted unique identification code of the charging station.

2. An apparatus according to claim 1, wherein the apparatus is further configured to determine if the charging station identified by the unique identification code is a public or limited access charging station.

3. An apparatus according to claim 1, wherein the apparatus is configured to route the launched charging station workflow to an identification site in case the source of the received encrypted unique identification code of a charging station is a world wide web server.

4. An apparatus according to claim 1, wherein the apparatus is configured to route the launched charging station workflow to the application control in case the source of the received encrypted unique identification code of a charging station is an application server.

5. An apparatus according to claim 1, wherein the apparatus is further configured to determine the charging station identified by the unique identification code is in limited use; and in response to the determined limited use the apparatus is further configured to route the charging station workflow to request a password.

6. An apparatus according to claim 1, wherein the apparatus is further configured to determine the charging station identified by the unique identification code is in service.

7. An apparatus according to claim 1, wherein the charging station workflow is one of the following: a charging process, charging station configuration, charging station installation or charging station analysis.

8. A system comprising:
a service server, wherein the service server is an apparatus according claim 1;
a world wide web server; and
an application server;
wherein one of the world wide web server and the application server is configured to receive encrypted unique identification code of a charging station.

9. A system according to claim 8, wherein the system further comprises a charging station associated with a unique identification code, wherein the unique identification code is provided in a form of a permanent code comprising a domain name part and an encrypted unique identification code.

10. A system according to claim 9, wherein the unique identification code is provided in a form of a QR code.

11. A system according to claim 9, wherein the system further comprises a mobile device, wherein the mobile device is used to read the unique identification code and to send the unique identification code to the service server via the world wide web server or the application server.

12. A method for initiating a charging station workflow, wherein the method comprises:
reading a unique identification code of a charging station using a mobile device; and
transmitting the read unique identification code of a charging station to an apparatus comprising:
at least one processor configured to execute computer program code;
at least one memory configured to store computer program code; and
at least one network interface configured to communicate with external data communication devices,
wherein the apparatus is configured to receive an encrypted unique identification code of a charging station from a world wide web server or an application server, wherein the apparatus is configured to:
determine the source of the received encrypted unique identification code of the charging station;
decrypt the received encrypted unique identification code of the charging station; and
launch a charging station workflow in accordance with the determined source and decrypted unique identification code of the charging station;
or to a service server, wherein the service server is an apparatus comprising:
at least one processor configured to execute computer program code;
at least one memory configured to store computer program code; and
at least one network interface configured to communicate with external data communication devices,
wherein the apparatus is configured to receive an encrypted unique identification code of a charging station from a world wide web server or an application server, wherein the apparatus is configured to:
determine the source of the received encrypted unique identification code of the charging station;
decrypt the received encrypted unique identification code of the charging station; and
launch a charging station workflow in accordance with the determined source and decrypted unique identification code of the charging station.
